(19) United States
(12) Patent Application Publication
(10) Pub. No.: US 2017/0050496 A1
(43) Pub. Date: Feb. 23, 2017

(54) VENTILATION UNIT FOR VEHICLE AIR-CONDITIONING DEVICE

(71) Applicant: DENSO CORPORATION, Kariya-city, Aichi-pref. (JP)

(72) Inventor: Hirohisa MOTOMURA, Kariya-city (JP)

(21) Appl. No.: 15/118,800

(22) PCT Filed: May 12, 2015
(86) PCT No.: PCT/JP2015/002413

§ 371 Date: Aug. 12, 2016

(30) Foreign Application Priority Data
May 15, 2014 (JP) 2014-101575

(51) Int. Cl. B60H 3/06; B60H 1/32

(52) U.S. Cl. CPC B60H 3/0616; B60H 3/0641; B60H 1/3233; B60H 2003/065

(57) ABSTRACT

A ventilation unit for a vehicle air-conditioning device has a filter element, a filter frame, a wall portion, a blower case, and a blower. The filter element is disposed in an air inlet of the vehicle air-conditioning device. The filter frame houses the filter element. The wall portion is provided in a standing position around the filter element housed in the filter frame. The blower case is attached to the filter frame. The filter frame is coupled with the blower case to be drawn out from the blower case together with the filter element in a drawing direction parallel to an upper surface of the filter element. The wall portion is disposed at a location corresponding to at least a rear side of two sides facing each other in the drawing direction and protrudes upward over the upper surface of the filter element.

### CROSS REFERENCE TO RELATED APPLICATION

This application is based on Japanese Patent Application No. 2014-101575 filed on May 15, 2014, the disclosure of which is incorporated herein by reference.

### TECHNICAL FIELD

The present disclosure relates to a ventilation unit is for a vehicle air-conditioning device that supplies a conditioned air into a room of the vehicle.

The ventilation unit is provided in a portion through which air is taken from an outside of the vehicle into an air conditioning duct. Especially, the present disclosure relates to a ventilation unit for a vehicle air-conditioning device that has a filter frame housing a filter element.

### BACKGROUND ART

A vehicle air conditioner increases a pressure of outside air outside a vehicle and inside air inside of the vehicle by a blower provided in a ventilation unit, and supplies the air into an air conditioning duct. The air conditioning duct therein has an evaporator cooling air and a heater core heating air.

Air is cooled by passing between cooling fins of the evaporator. In this occasion, water in the air is condensed and attached to the cooling fins. A drain path is provided below the conditioning duct to emit the water to an outside of the air conditioning duct. The drain path is a passage having a pipe shape, and a large volume of water is stored in the air conditioning duct when the drain path is clogged with foreign material such as clay. As a result, an abnormality such as an unusual odor may occur.

A ventilation unit is configured, for example, as described in Patent Literature 1. According to a device described in Patent Literature 1, a blower configured by a multi-blades centrifugal fan is arranged on an upstream side of the evaporator in the air conditioning duct. The blower is rotated by a blower motor.

A filter element is arranged on an upstream side of the blower. The filter element is made of a non-woven fabric and has an upper surface formed in a plate shape. An inside air/outside air switching damper is arranged above the filter element, and the inside air from inside of the vehicle and the outside air from outside of the vehicle are selectively filtered in the filter element. The filter element is housed in a case called filter frame. The filter frame is drawn out from a blower case in a horizontal direction, and the filter frame is taken out from the blower case, when replacing the filter element.

The filter frame has wall portions located on four sides of the filter element respectively, and the wall portions has a height that is equal to a height of the filter element.

### PRIOR ART LITERATURES Patent Literature

Patent Literature 1: JP 2011-194991 A

### SUMMARY OF INVENTION

The inventor of the present disclosure analyzed a matter that causes a clog of the drain path. A foreign material should not come into the outside air from outside the vehicle since the outside air is filtered by the filter element. However, the drain path is actually clogged.

As a result of examinations of the foreign material clogged in the drain path, crushed withered leaves and sand are included in the foreign material, and thereby it is obvious that the foreign material is from outside of the vehicle. The inventor found that the foreign material such as sand or withered leaves stored on a surface of a previously set filter element falls from the surface into the blower located below when replacing the filter element.

The filter frame and the filter element waggle when the filter element is drawn out with the filter element in the horizontal direction. At this time, the foreign material such as withered leaves stored on the filter element falls from an end of the filter element. As a result, the foreign material such as a leave of a plant stored on the filter element falls when replacing the filter element, and thereby a drain hole of a drain portion of the air conditioner is clogged, and eventually interrupting a water discharge.

According to the Patent Literature 1, the wall portions are arranged around the filter element, and a height of the filter element and a height of the wall portions are equal to each other. As a result, the filter frame and the filter element waggle when the filter element is drawn out with the filter element in the horizontal direction, and thereby the foreign material such as withered leaves stored on the filter element falls from an end of the filter element over the wall portions.

The present disclosure addresses the above issues, and thus it is an objective of the present disclosure to provide a ventilation unit for a vehicle air-conditioning device in which a foreign material hardly falls from a surface of a filter element when replacing the filter element.

It should be noted that features described as conventional techniques in

Patent Literature 1 can be referred to or introduced in the specification of the present disclosure for a description of technical features.

A ventilation unit for a vehicle air-conditioning device of the present disclosure uses the following techniques. A ventilation unit for a vehicle air-conditioning device has a filter element, a filter frame, a wall portion, a blower case, and a blower. The filter element is formed by a filter medium and disposed in an air inlet of the vehicle air-conditioning device. The filter frame houses the filter element. The wall portion is provided in a standing position around the filter element housed in the filter frame. The blower case is attached to the filter frame. The blower is housed in the blower case. The filter frame is coupled with the blower case to be drawn out from the blower case together with the filter element in a drawing direction parallel to an upper surface of the filter element. The wall portion is disposed around the filter element at a location corresponding to at least a rear side of two sides facing each other in the drawing direction and protrudes upward over the upper surface of the filter element.

According to the ventilation unit for a vehicle air-conditioning device of the present disclosure, the wall portion is provided around the filter element and protrudes upward over the upper surface of the filter element, and therefore a foreign material stored on the upper surface of the filter element can be prevented from falling into the blower located below when drawing out the filter frame from the blower case.

### BRIEF DESCRIPTION OF DRAWINGS

FIG. 1 is an exploded perspective view illustrating a blower mounting portion and a filter frame of a ventilation unit according to a first embodiment.

FIG. 2 is a perspective view illustrating the filter frame according to the first embodiment.

FIG. 3 is an explanatory diagram for explaining a schematic configuration of an inside of an air-conditioning device according to the first embodiment.

FIG. 4 is a perspective diagram explaining a state that a filter element is arranged in the filter frame, and the filter frame waggles, according to the first embodiment.

FIG. 5 is a perspective diagram illustrating a state that a wall portion of the filter frame is omitted, according to a comparable example of the first embodiment.

FIG. 6 is a perspective view illustrating a filter frame according to a second embodiment.

FIG. 7 is an exploded perspective view illustrating a blower mounting portion and the filter frame of a ventilation unit in a case of using the filter frame of the second embodiment.

FIG. 8 is a partial cross-sectional view illustrating a filter frame and a filter element according to a third embodiment.

FIG. 9 is an exploded perspective view illustrating a blower mounting portion and the filter frame of a ventilation unit according to a third embodiment.

FIG. 10 is a partial cross-sectional view illustrating a filter frame and a filter element according to a fourth embodiment.

### DESCRIPTION OF EMBODIMENTS

Embodiments of the present disclosure will be described hereinafter referring to drawings. In the embodiments, a part that corresponds to or equivalents to a matter described in a preceding embodiment may be assigned with the same reference number, and descriptions of the part may be omitted. When only a part of a configuration is described in an embodiment, parts described in preceding embodiments may be applied to the other parts of the configuration.

The parts may be combined even if it is not explicitly described that the parts can be combined. The embodiments may be partially combined even if it is not explicitly described that the embodiments can be combined, provided there is no harm in the combination.

### First Embodiment

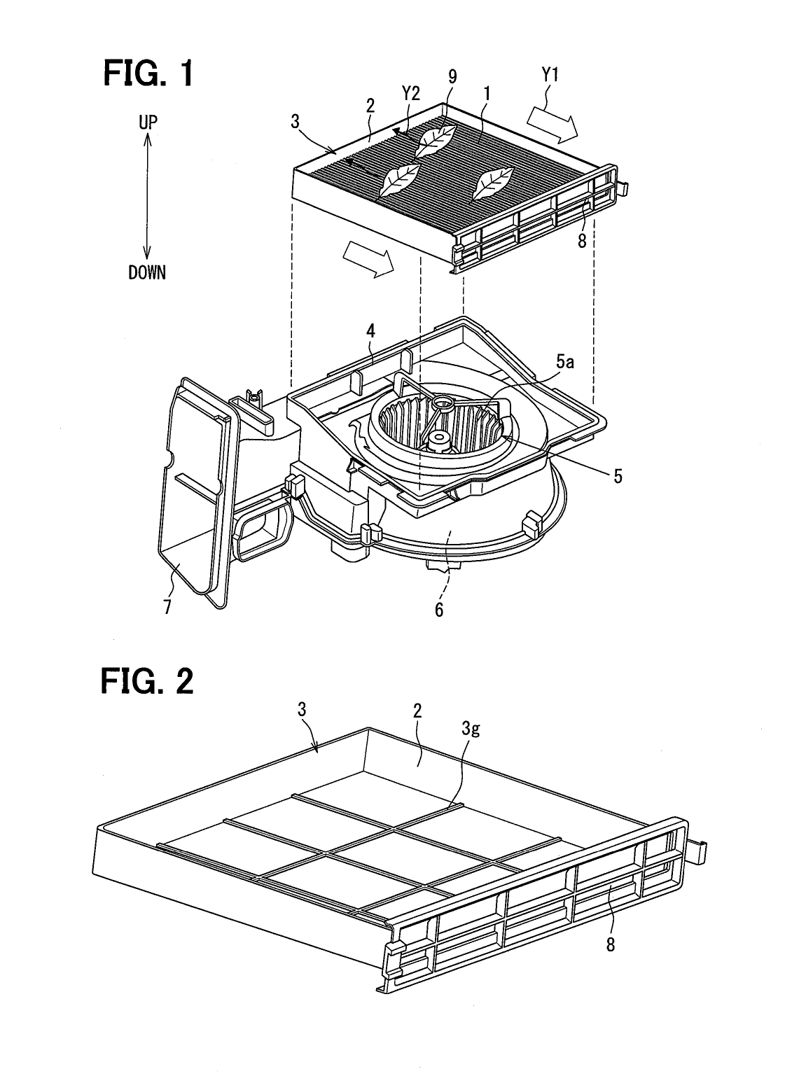

A first embodiment will be described hereinafter referring to FIG. 1 through FIG. 4. A ventilation unit for a vehicle air-conditioning device has a filter element 1 and a filter frame 3. The filter element 1 is formed by a filter medium and disposed in an air inlet of the vehicle air-conditioning device. The filter frame 3 has a wall portion 2 provided around the filter element 1. The filter medium configuring the filter element is made of a non-woven fabric and has elasticity. The filter frame 3 is made of resin by molding and coupled with a blower case 4. The blower case 4 therein houses a blower 5.

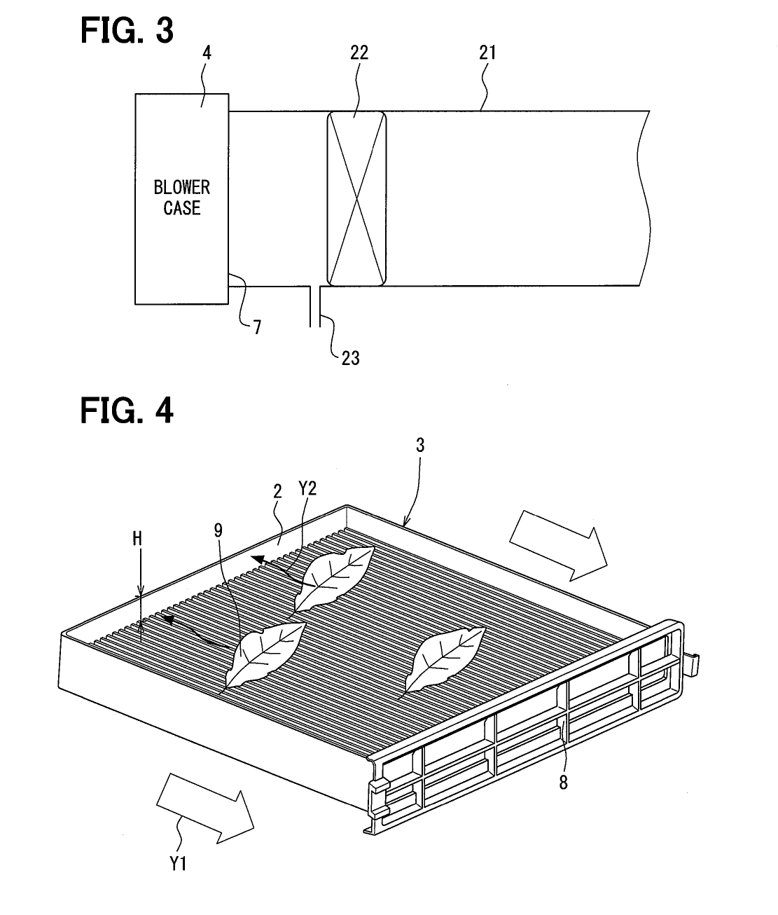

The blower 5 has a multi-blades centrifugal fan 5a and a fan motor rotating the multi-blades centrifugal fan 5a. The blower case 4 has a discharge port 7 connected to an air conditioning duct 21 of the vehicle air-conditioning device, and air blowing from the blower 5 flows into the air conditioning duct 21 shown in FIG. 3.

As shown in FIG. 3, an evaporator 22 is disposed in the air conditioning duct 21 to check a flow of air. The evaporator 22 cools air. A condensed water is generated in the evaporator 22 and emitted to an outside of the air conditioning duct 21 through a drain path 23 provided below the air conditioning duct 21.

The wall portion 2 of the filter frame 3 is provided in a standing position around the filter element 1. The wall portion 2 has a height that is more than or equal to 5 mm (preferably more than or equal to 10 mm) higher than a height (i.e., a thickness) from a bottom to an upper surface of the filter element 1. The filter frame 3 is drawn out from the blower case 4 together with the filter element 1, as shown by arrow Y1, in a direction parallel to the upper surface of the filter element 1. In the drawing out, a user holds a surface cover 8 of the filter frame 3 with hands. The previously set filter element 11 is replaced with a new filter element 11 after the filter frame 3 is drawn out.

The blower case 4 is a case made of resin and surrounds the multi-blades centrifugal fan 5a. The filter frame 3 is disposed on the blower case 4 on an upper side and coupled with the blower case 4. The blower case 4 has a passage in which air flows spirally. An inlet of the passage is a lower portion of the filter element 1, and the discharge port 7 is connected to the air conditioning duct 21 of the vehicle air-conditioning device as shown in FIG. 1 and FIG. 3.

The wall portion 2 of the filter frame 3 surrounds the filter element 1. As a result, a foreign material 9 is intercepted by the wall portion 2 when moving on the filter element 1 as shown by arrow Y2 as shown in FIG. 1 and FIG. 4. Accordingly, the foreign material 9 can be prevented from falling into the blower 5. The crushed foreign material 9 is thereby prevented from attaching to the evaporator 22, and a clog of the drain path 23 caused by the crushed foreign material 9 falling with condensed water can be suppressed.

In a case that the foreign material 9 stored on the filter element moves, the wall portion 2 of the filter frame 3 can suppress the fall of the foreign material 9 by configuring the wall portion 2 of the filter frame 3 such that a dimension from a center area of the upper surface of the filter element 1 to an upper end of the wall portion 2 is larger than or equal to 5 mm, preferably larger than or equal to 10 mm. That is, the foreign material can be held on the upper surface of the filter element 1 (e.g., the center area of the upper surface).

The foreign material 9 is not attached to a surface of the evaporator 22 disposed in the air conditioning duct 21, and thereby the drain path 23 is not clogged, since the foreign material 9 stored on the filter element 1 does not fall into the blower 5 when replacing the filter element 1. Here, it should be noted that the center area of the filter element 1 means an area located generally at a center of the filter element 1, and not means a center point.

### Comparable Example

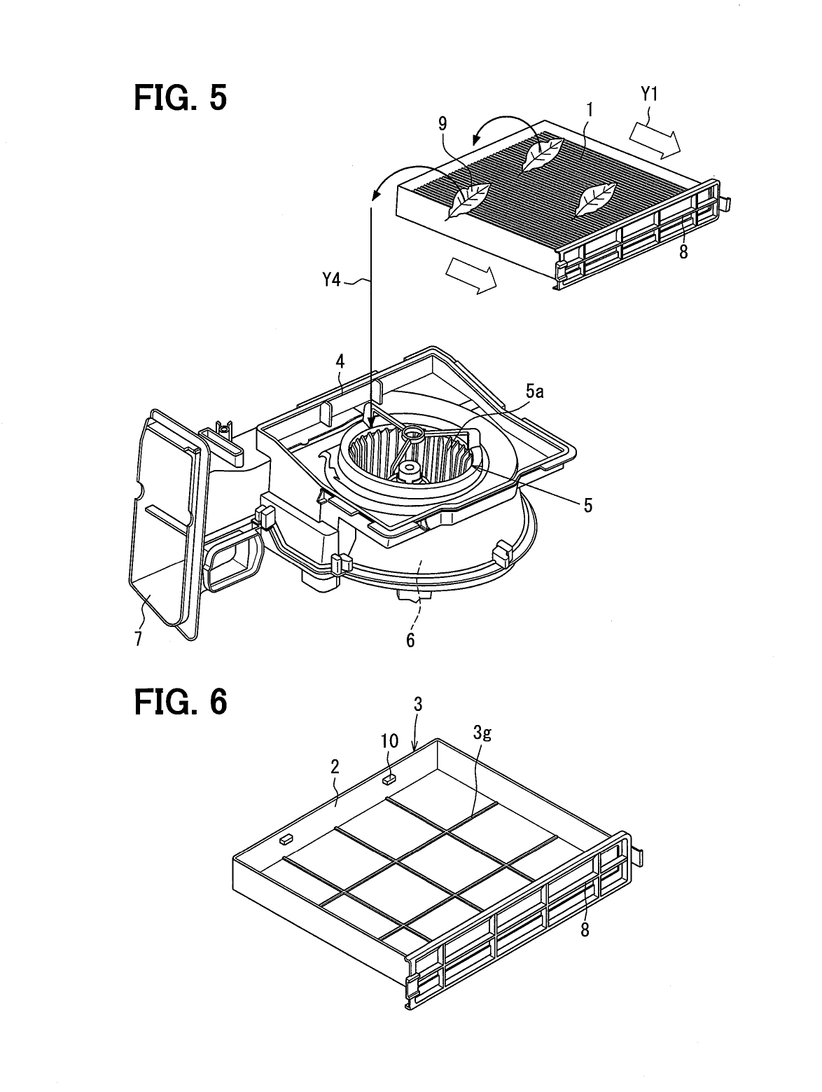

FIG. 5 shows a comparable example of the above-described embodiment. As shown in FIG. 5, according to the comparable example, the wall portion 2 of the filter frame 3 is not provided around the filter element, or the wall portion 2 is provided to have the same height as the filter element 1. Accordingly, the foreign material 9 falls into a suction port of the blower 5 by drawing the previously set filter element 1 in a direction shown by arrow Y1 when replacing the filter element 1. The blower 5 has the multi-blades centrifugal fan 5a and crushes the foreign material 9 when being rotating. The crushed foreign material 9 is attached to the evaporator 22 disposed in the air conditioning duct 21 and flows to the drain path 23 with the condensed water, and thereby the drain path 23 is clogged.

### Second Embodiment

A second embodiment will be described hereinafter. In the following embodiments, a part that corresponds to a matter described in the above-described first embodiment may be assigned with the same reference number, and redundant explanation for the part may be omitted. A feature that is different from the first embodiment will be described in the following embodiments. In the following embodiments, a part assigned with the same reference number corresponds to a matter described in the above-described first embodiment, and the foregoing explanation may be referred thereto.

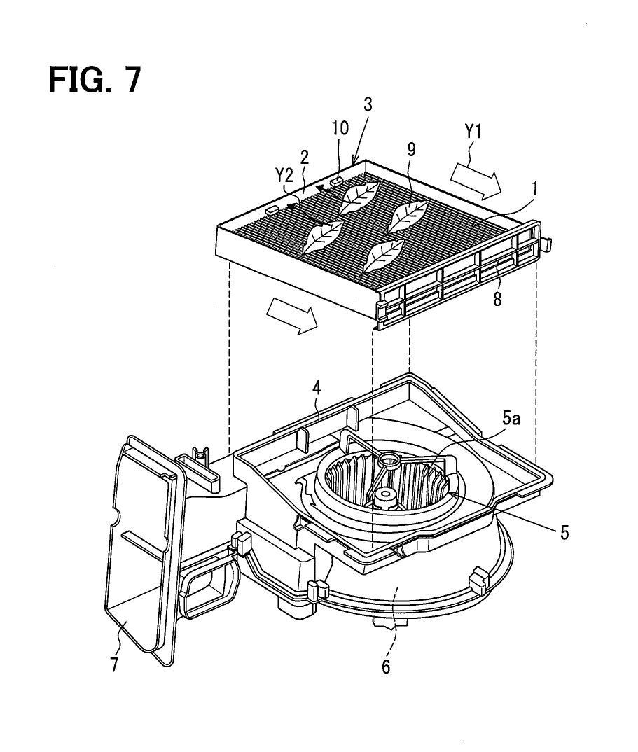

The filter frame 3 has stoppers 10 that are protruding portions (i.e., protruding clicks) made of resin and molded integrally with the wall portion 2 as shown in FIG. 6 and FIG. 7. A grille 3g is provided on a bottom portion of the filter frame 3. However, the grille 3g can be omitted by supporting the filter element 1 by, for example, an upper portion of the blower 5.

According to the present embodiment, a quantity of components can be prevented from increasing, since the stoppers 10 are made of resin and molded integrally with the wall portion 2 of the filter frame 3 and have a protrusion shape. Moreover, the filter element 1 has a great flexibility, and therefore the filter element 1 can be disposed in the filter frame 3 on a lower side of the stoppers 10 by deforming the filter element 1 elastically even when the stoppers 10 protrude inward from the wall portion 2.

FIG. 7 shows a condition that the filter element 1 is disposed under the stoppers 10. The stoppers 10 supports the upper end of the filter element 1 when the filter frame 3 is drawn with the filter element 1 as shown by arrow Y1 in FIG. 7, and therefore the filter element 1 does not waggle in an up-down direction.

As a result, the fall of the foreign material 9 such as withered leaves into the blower 5 can be suppressed. Furthermore, the stoppers 10 are positioned such that the dimension from the center area of the upper surface (i.e., a surface on an upper side) of the filter element 1 to the upper end of the wall portion 2 can be secured to be larger than or equal to 5 mm, preferably larger than or equal to 10 mm.

The stoppers 10 are molded integrally with the wall portion 2 in the present embodiment. However, the stoppers 10 may be molded separately from the wall portion 2. Further, the stoppers 10 may have a pin shape that inserted to a hole passing through the wall portion 2 and that engages with the filter element 1. In addition, the stoppers 10 is not limited to press the upper surface of the filter element 1 and may be dig into a side surface of the filter element 1 to support the filter element 1. The stoppers 10 are not limited to be made of resin and may be screws made of metal.

### Third Embodiment

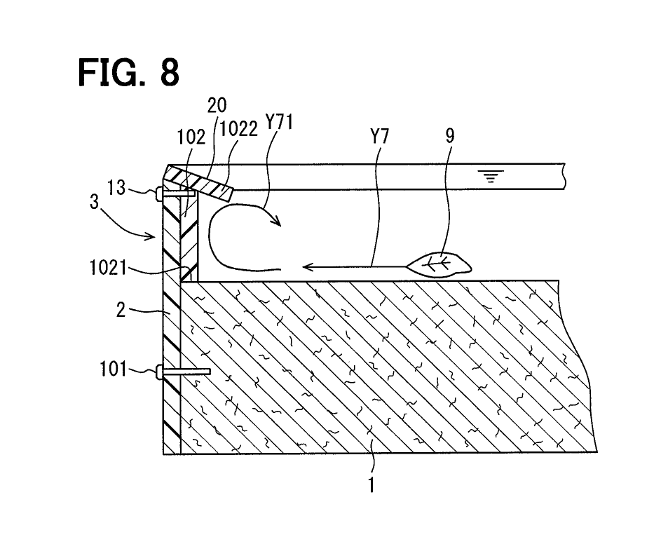

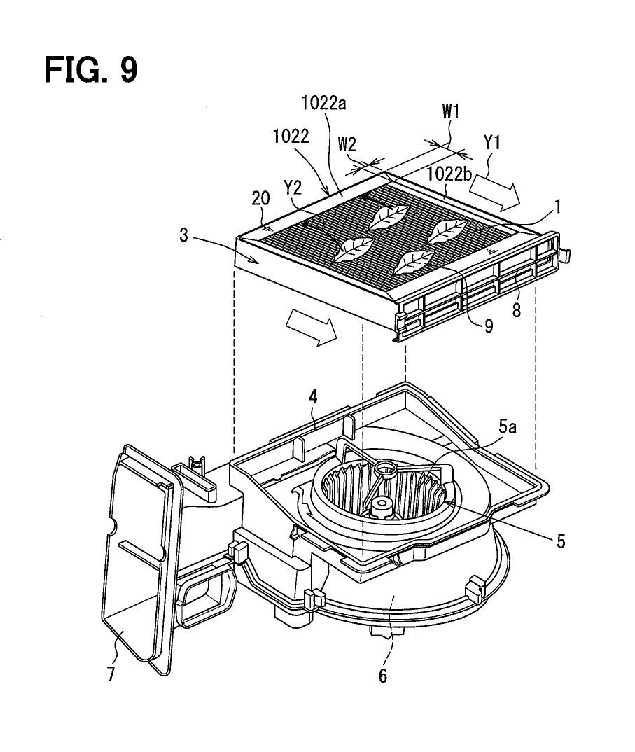

A third embodiment will be described hereinafter. In the present embodiment, a feature that is different from the above-described embodiments will be described. Each of the stoppers 10 has a first stopper portion 101 and a second stopper portion 102 as shown in FIG. 8 and FIG. 9. The first stopper portion 101 is provided separately from the wall portion 2 of the filter frame 3 and configured by a screw that is inserted from outside of the wall portion 2.

The second stopper portion 102 is configured by a cover covering a circumference of the filter frame 3. The cover providing the second stopper portion 102 is positioned to fit an opening rim of an upper end of the filter flame 3.

The second stopper portion 102 configured by the cover can be inserted to an inside of the wall portion 2 from an upper side of the wall portion 2 on a condition that the filter element 1 is arranged in the filter frame 3. The cover configuring the second stopper portion 102 has a T-shape in cross section and includes a lower end portion 1021. The lower end portion 1021 presses the upper end of the filter element 1, and thereby a waggling of the filter element 1 can be suppressed. The screw configuring the first stopper portion 101 may be omitted.

The cover configuring the second stopper portion 102 has a roof portion 1022 that covers a periphery of an upper opening end of the filter frame 3. The roof portion 1022 has a shape extending inward from a side adjacent to the opening rim of the filter frame 3 and covers the circumference of the filter element 1. That is, the second stopper portion 102 is provided to cover the periphery of the upper opening end of the filter frame 3 on which the filter element 1 is exposed. The waggling of the filter element 1 thereby can be suppressed. At the same time, the foreign material 9 is rebounded as shown by arrow Y71 by the roof portion 1022 of the cover covering the periphery of the upper opening end of the filter frame 3 when the foreign material 9 on the upper surface of the filter element 1 moves as shown by arrow Y7 in FIG. 8. The foreign material 9 thereby can be prevented from falling toward an outside of the filter frame 3. The roof portion 1022 configuring a part of the wall portion 2 has an inclined surface 20 to guide the foreign material 9 to fall toward an inner side of the filter element 1.

As shown in FIG. 9, a width W1 of a first roof portion 1022a in a direction perpendicular to a drawing direction shown by arrow Y1 in which the filter frame 3 is drawn out in the replacing is set to be larger than a width W2 of a second roof portion 1022b in a direction parallel to the drawing direction shown by arrow Y1 (W1>W2).

Conversely, by setting the widths to satisfy W2<W1, the filter element 1 is easily disposed in the filter frame 3 through the first roof portion 1022a and an inside of the second roof portion 1022b of the cover while restricting the fall of the foreign material 9 as much as possible. The cover configuring the second stopper portion 102 may be attached to the filter frame 3 by a screw 13 after removing the screw 13 shown in FIG. 8 and disposing the filter element 1 in the filter frame 3. The screw 13 may be omitted. The roof portion 1022 is pressed downward by an own weight and wind generated by the blower 5 in a case of omitting the screw 13.

### Fourth Embodiment

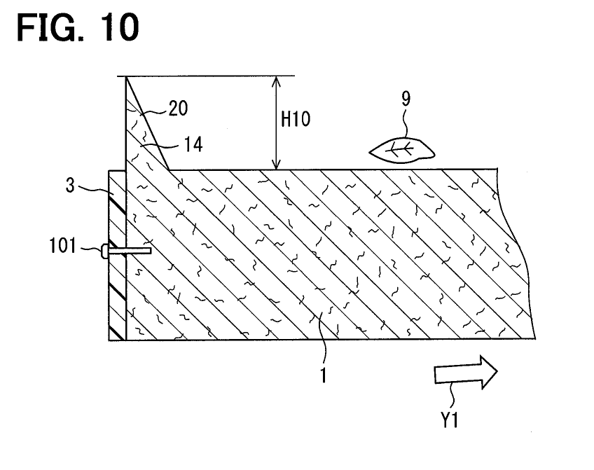

A fourth embodiment will be described hereafter. The fourth embodiment will be described with a part that is different from the above-described embodiments. The filter element 1 shown in FIG. 10 is made of a non-woven fabric that is formed by pressing, and a protruding portion 14 that has a plate shape and configures the wall portion 2 in the circumference of the filter element 1. The protruding portion 14 has a triangle shape and has a sharp end in cross section.

A height H10 from the center area of the upper surface of the filter element 1 to an upper end of the protruding portion 14 is set to be larger than or equal to 5 mm, preferably larger than or equal to 10 mm. According to such configuration, the foreign material 9 does not fall to a lower side of the filter element 1 since the protruding portion 14 configuring the wall portion 2 is provided, even when the foreign material 9 moves in a direction shown by arrow Y2 by a waggle of the filter element 1 when replacing the filter element 1. The protruding portion 14 has the triangle shape and the sharp end in cross section, and thereby a foreign particle is hardly attached to a tip portion. The foreign particle slips off along the inclined surface 20 provided on an inner side of the filter element 1.

According to the fourth embodiment shown in FIG. 10, the protruding portion 14 that configures the wall portion 2 and protrudes upward over the upper surface of the filter element 1 is provided around the circumference of the filter element 1. That is, the protruding portion 14 configuring the wall portion 2 is provided as a part of the filter element 1. The protruding portion 14 configuring the wall portion 2 has the inclined surface 20 that has the tapered triangle shape in cross section, and thereby the foreign material 9 slips off to the inner side of the filter element 1 by the protruding portion 14.

The wall portion 2 configured by the protruding portion 14 can be provided integrally with the circumference of the filter element 1 by providing the filter element 1 made of non-woven fabric by pressing sequentially.

The filter frame 3 is drawn out from the blower case together with the filter element 1 in the direction (shown by arrow Y1) parallel to the upper surface of the filter element 1 when replacing the filter element, similar to the first embodiment.

According to the present embodiment, the protruding portion 14 configuring the wall portion in the circumference of the filter element 1 protrudes upward over the center area of the upper surface of the filter element 1 when the filter frame 3 is drawn out from the blower case 4. The foreign material 9 stored on the upper surface of the filter element 1 thereby can be prevented from falling into the blower.

The protruding portion 14 configuring the wall portion is configured by the wall portion provided integrally with the filter element. The foreign material stored on the upper surface of the filter element therefore can be prevented from falling into the blower by the wall portion provided integrally with the filter element even in a case that the filter frame 3 holding the filter element has a conventional structure.

According to the present embodiment shown in FIG. 10, the first stopper portion 101 that passes through the wall portion 2 of the filter frame 3 and configures the stopper 10 is inserted to the side surface of the filter element to restrict the waggle of the filter element. However, the first stopper portion 101 can be omitted.

### Other Modifications

While the present disclosure has been described with reference to preferred embodiments thereof, it is to be understood that the disclosure is not limited to the preferred embodiments and constructions. The present disclosure is intended to cover various modification and equivalent arrangements within a scope of the present disclosure. It should be understood that structures described in the above-described embodiments are preferred structures, and the present disclosure is not limited to have the preferred structures.

The stopper fixing the filter element may be omitted as long as the wall portion is provided to prevent the foreign material from falling from the filter element when the filter element waggles in the replacement.

The wall portion is not necessary to be provided all along the filter element and may be provided at least one of two sides of a rear side and a front side of the filter element facing each other in a direction parallel to the drawing direction in which the filter frame is drawn. In this case, the wall portion is preferably provided on the rear side in the drawing direction. Alternatively, as shown in FIG. 2, the wall portion may be provided along the filter element at least at positions corresponding to two side facing in a direction perpendicular to the drawing direction and may protrude upward over the upper surface of the filter element.

A height of a wall of the filter frame may be set as required when the filter element itself has the wall portion.

A surface of the filter element may be corrugated, not flat, depending on kinds of the filter element. In this case, the height of the wall may be set to be more than or equal to 5 mm, preferably more than or equal to 10 mm higher than a height of an upper surface connecting corrugate tips of the filter element.

Alternatively, in a case that the surface of the filter element has protruding portions and recessed portions, the height of the wall may be set to be more than or equal to 5 mm, preferably more than or equal to 10 mm higher than a height of the protruding portion of which protruding amount is the largest among the protruding portions in the center area of the filter element 1.

Operation effects of the above-described embodiments of the present disclosure are listed as follows. The wall portion is provided around the filter element and protrudes upward over the upper surface of the filter element, and therefore a foreign material stored on the upper surface of the filter element can be prevented from falling into the blower located below when drawing out the filter frame from the blower case.

The wall portion provided integrally with the filter element can prevent the foreign material stored on the upper surface of the filter element from falling into the blower.

The foreign material can be prevented from falling from the filter element, and thereby the foreign material can be prevented from being attached to the evaporator, and the clog of the drain path caused by the foreign material falling with the condensed water can be suppressed.

The wall of the filter frame can certainly suppress the fall of the foreign material even when the foreign material stored on the filter element moves, since the dimension from the upper end of the filter element to the upper end of the wall portion is larger than or equal to 5 mm.

An increase of a quantity of components can be suppressed since the stoppers are made of resin and molded integrally with the wall of the filter frame. The filter element has a great flexibility, and therefore the filter element can be disposed in the filter frame on the lower side of the stoppers by deforming the filter element elastically even when the stoppers protrude inward from the wall portion.

The stopper portion configured by the cover can be inserted to the inside of the wall portion from the upper side of the wall portion on the condition that the filter element is arranged in the filter frame, and thereby the waggle of the filter element can be suppressed.

The waggle of the filter element is suppressed by the cover covering the periphery of the upper opening end of the filter frame. The periphery of the upper opening end of the filter frame is covered by the roof portion of the cover, and thereby the foreign material can be prevented from falling from the filter frame even when the foreign material on the surface of the filter element moves.

The foreign material can be prevented from being attached to an upper area of the wall portion since the wall portion has the inclined surface 20 that guides the foreign material to fall to the inner side of the filter element 1, in a case that the wall portion and the filter element are configured integrally with each other.

What is claimed is:

1. A ventilation unit for a vehicle air-conditioning device comprising:
a filter element that is formed by a filter medium and disposed in an air inlet of the vehicle air-conditioning device;
a filter frame that houses the filter element;
a, wall portion that is provided in a standing position around the filter element housed in the filter frame;
a blower case that is attached to the filter frame; and
a blower that is housed in the blower case, wherein
the filter frame is coupled with the blower case to be drawn out from the blower case together with the filter element in a drawing direction parallel to an upper surface of the filter element, and
the wall portion is disposed around the filter element at a location corresponding to at least a rear side of two sides facing each other in the drawing direction and protrudes upward over the upper surface of the filter element.

2. The ventilation unit for a vehicle air-conditioning device according to claim 1, wherein
the wall portion is disposed around the filter element at the location corresponding to at least a front side of the two sides facing each other in the drawing direction and protrudes upward over the upper surface of the filter element.

3. The ventilation unit for a vehicle air-conditioning device according to claim 1, wherein
the blower case is coupled with an air conditioning duct of the vehicle air-conditioning device, and
the air conditioning duct has:
an evaporator that cools air in the air conditioning duct; and
a drain path that is located below the air conditioning duct and drains a condensed water provided in the evaporator to an outside of the air conditioning duct.

4. The ventilation unit for a vehicle air-conditioning device according to claim 1, the ventilation unit further comprising
a stopper that restricts a vibration of the filter element in the filter frame, wherein
the stopper is made of resin by molding integrally with the wall portion provided in the filter frame and has a protrusion shape.

5. The ventilation unit for a vehicle air-conditioning device according to claim 1, the ventilation unit further comprising
a stopper that restricts a vibration of the filter element in the filter frame, wherein
the stopper is provided separately from the filter frame and has a pin shape that passes through the wall portion of the filter frame and that engages with the filter element.

6. The ventilation unit for a vehicle air-conditioning device according to claim 1, the ventilation unit further comprising
a stopper that restricts a vibration of the filter element in the filter frame, wherein
the stopper is provided separately from the filter frame.

7. The ventilation unit for a vehicle air-conditioning device according to claim 1, the ventilation unit further comprising
a cover that is positioned to fit an opening rim of an upper end of the filter frame.

8. The ventilation unit for a vehicle air-conditioning device according to claim 1, wherein
the wall portion is configured integrally with the filter element.

9. The ventilation unit for a vehicle air-conditioning device according to claim 1, wherein
the filter element housed in the filter frame has a height from a center area of the upper surface of the filter element to an upper end of the wall portion, and the height is larger than or equal to 5 mm.

10. The ventilation unit for a vehicle air-conditioning device according to claim 7, wherein
the cover has:
a lower end portion that has a shape extending downward and presses the upper surface of the filter element; and
a roof portion that has a shape extending inward from a side adjacent to the opening rim and covers a periphery of the filter element.

11. The ventilation unit for a vehicle air-conditioning device according to claim 8, wherein
the wall portion is provided on the upper wall surface of the filter element in the standing position, and the wall portion has a taper shape in cross section and has a inclined surface on an inner side of the filter element.

12. A ventilation unit for a vehicle air-conditioning device, comprising:
a filter element that is formed by a filter medium and disposed in an air inlet of the vehicle air-conditioning device;
a filter frame that houses the filter element;
a wall portion that is provided in a standing position around the filter element housed in the filter frame;
a blower case that is attached to the filter frame; and
a blower that is housed in the blower case, wherein
the filter frame is configured to be drawn out from the blower case together with the filter element in a specified direction of the filter element, and
the filter element is replaceable on a condition that the filter frame is drawn out from the blower case,
the wall portion is disposed around the filter element at a location corresponding to at least a rear side of two sides facing each other in the drawing direction and protrudes upward over the upper surface of the filter element.

13. The ventilation unit for a vehicle air-conditioning device according to claim 1, wherein
the wall portion is disposed around the filter element at a location corresponding to at least two sides facing each other in a direction perpendicular to the drawing direction and protrudes upward over the upper surface of the filter element.
